(19) United States
(12) Patent Application Publication
(10) Pub. No.: US 2005/0230961 A1
(43) Pub. Date: Oct. 20, 2005

(54) Tamper evident label and method for using a tamper evident label

(76) Inventor: Carey L. Walley, Springboro, OH (US)

Correspondence Address: MARK P. LEVY, ESQ.;THOMPSON HINE LLP., 2000 COURTHOUSE PLAZA NE, 10 W. SECOND STREET, DAYTON, OH, 45402-1758, US

(21) Appl. No.: 10/824,002

(22) Filed: Apr. 14, 2004

(51) Int. Cl. B42D 15/00

(52) U.S. Cl. 283/81

(57) ABSTRACT

A tamper evident label system including a label sheet having an adhesive located thereon and at least one tear guide line or score line located thereon or therethrough. The label sheet includes indicia indicating the tamper evident nature of the label.

The present invention is directed to a tamper evident label, and more particularly, to a tamper evident label including tear guide lines or score lines located thereon.

### BACKGROUND

It is often desired to send documents and other components in a secure manner using tamper evident envelopes, packages or other containment means so that any attempted opening or tampering with the containment means is apparent. To that end, various tamper evident labels and envelopes have been used. However, existing tamper evident labels and envelopes may be able to be relatively easily defeated, and may not provide clear evidence of attempted opening or tampering. Accordingly, there is a need for an improved tamper evident label.

### SUMMARY

The present invention is a tamper evident label which is difficult to defeat and which provides clear visual evidence of any attempted tampering or opening of the associated envelope, package or containment means. In particular, in one embodiment the invention is a tamper evident label system including a label sheet having an adhesive located thereon and at least one tear guide line or score line located thereon or therethrough. The label sheet includes indicia indicating the tamper evident nature of the label.

In another embodiment the invention is a tamper evident label system including a containment means including a body, an inner cavity having a mouth, and a flap. The flap is movable between a closed position wherein the flap generally covers the mouth, and an open position wherein the flap generally does not cover the mouth, and the flap is located in the closed position. The system further includes a label sheet having an adhesive located thereon and at least one tear guide line or score line located thereon or therethrough. The label sheet is adhered to the flap and to the body to maintain the flap in the closed position.

Other objects and advantages of the present invention will be apparent from the following description and the accompanying drawings.

### BRIEF DESCRIPTION OF THE DRAWINGS

FIG. 1 is a front view of one embodiment of the tamper evident label of the present invention;

FIG. 2 is a side view of the tamper evident label of FIG. 1.

FIG. 3 is a front view of a sheet of labels;

FIG. 4 is a front view of an alternate embodiment of the tamper evident label of the present invention;

FIG. 5 is a rear view of an envelope in its open position;

FIG. 6 is a rear view of the envelope of FIG. 5 in its closed position and with a tamper evident label fixed thereto; and

FIG. 7 is a rear view of the envelope of FIG. 6, with the flap opened.

### DETAILED DESCRIPTION

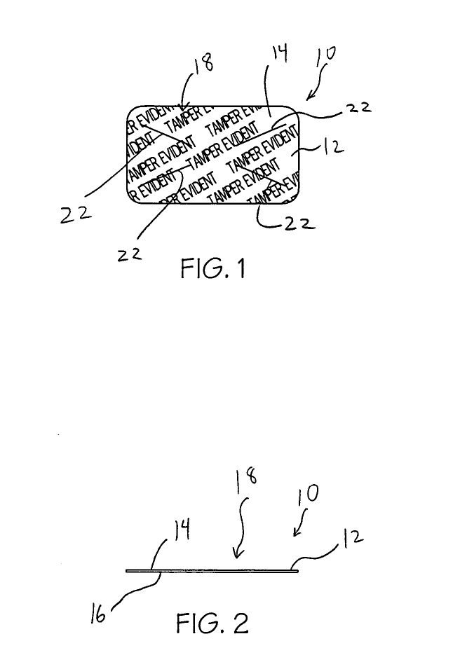

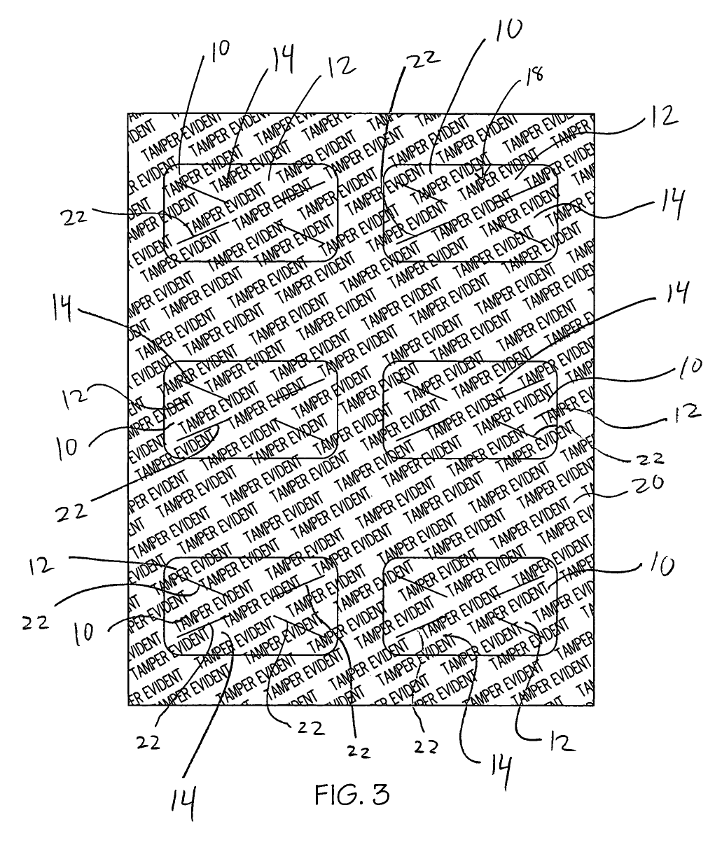

As shown in FIGS. 1 and 2, the tamper evident label of the present invention, generally designated 10, includes a label sheet 12 that is, in one embodiment, generally rectangular in top or front view. However, the label sheet 12 may take a wide variety of forms or shapes besides rectangular, including but not limited to square, circular, triangular, hexagonal oval, irregular, etc. The label sheet includes a text side 14 and an adhesive side 16. The text side 14 may include various indicia 18 located or printed thereon which indicate the tamper evident nature of the label 10. For example, the indicia 18 may include text such as “tamper evident,” “tamper resistant,” “tamper proof,” “confidential,” etc. If desired, a sheet of labels 10 may be provided (FIG. 3), each label 10 being die cut and secured to a release liner 20 so that each label 10 can be easily separated from the release liner 20 (i.e., by manually peeling the labels 10). FIG. 3 illustrates a sheet having six labels 10. However, it should be understood that the sheet may include more or less labels located thereon, including ten labels or various other numbers of labels.

The label sheet 12 may include an adhesive located on its adhesive side 16 to enable the label sheet 12 to be adhered to a substrate. The adhesive may be any of a wide variety of adhesive or binding means, and may include pressure sensitive adhesives, adhesives which require water to be activated, or various other adhesives. The adhesive is preferably a relatively strong adhesive such that when the adhesive (i.e., label sheet 12) is secured to the surface or substrate (such as an envelope or other paper or paper-based products), any attempted removal of the label sheet 12 will cause the label sheet 12 and/or substrate to tear or fragment before the adhesive releases. For example, when the label sheet 12 is adhered to paper, cardboard or the like, any attempted removal of the label sheet 12 will cause tearing, marring, marking or separation of the paper or cardboard substrate, or of the label 10. Thus, for example, the adhesive may have a peel force of three to four or more pounds per label measured perpendicular to the orientation of label 10 on a stainless steel base member.

The label sheet 12 may be made of any of a wide variety of materials including plastic, papers, foils and polymers, such as polyester films, polymers and vinyl chloride, polyethylene, polypropylene and the like. The indicia 18 may be printed with various inks or dyes, including water-insoluble inks, pigments, or the like.

As shown in FIG. 1, the label sheet 12 may include a plurality of tear guidelines or score lines 22 located thereon. In the illustrated embodiment, wherein the labels 10 are rectangular, the tear guidelines 22 are diagonally oriented; that is, each tear guideline 22 extends from a corner (or edge) of the label sheet 12 towards the center of the label sheet 12. Each tear guideline 22 may be spaced away from the outer perimeter of the label sheet 12. Each tear guideline 22 is a cut or an area of weakness or the like such that the tamper evident label 10 is tearable along the tear guideline 22 and/or along the ends of the tear guidelines 22. Thus, for example, the tear guidelines 22 may be perforation lines, areas of weakness, fold lines, score lines (cut either fully or partially through the thickness of the label sheet 12) and the like.

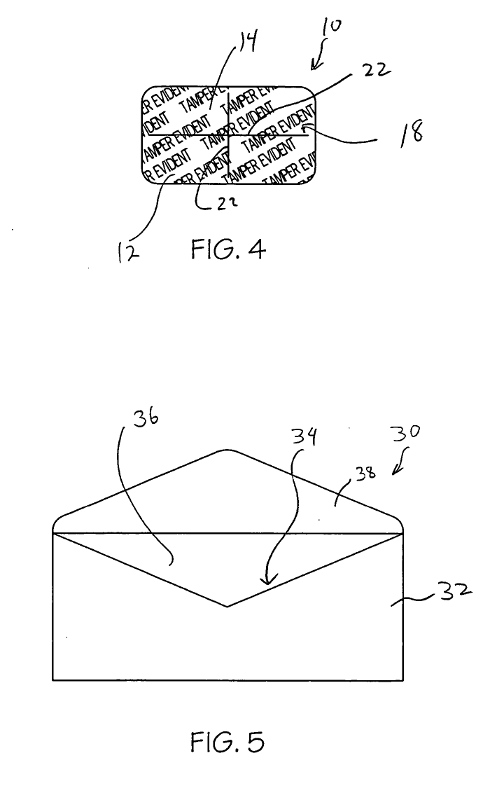

The shape and arrangement of the tear guidelines 22 may vary from that shown in FIGS. 1-3. For example, FIG. 4 illustrates an alternate embodiment of the label 10 wherein the tear guidelines 22 are two generally perpendicular intersecting tear guidelines 22 forming a generally “+” shape. The tear guidelines 22 may be desired to be arranged so as to allow the label 10 to be relatively easily torn along the tear guidelines 22 while simultaneously not significantly compromising the stiffness of the label 10 for ease of handling.

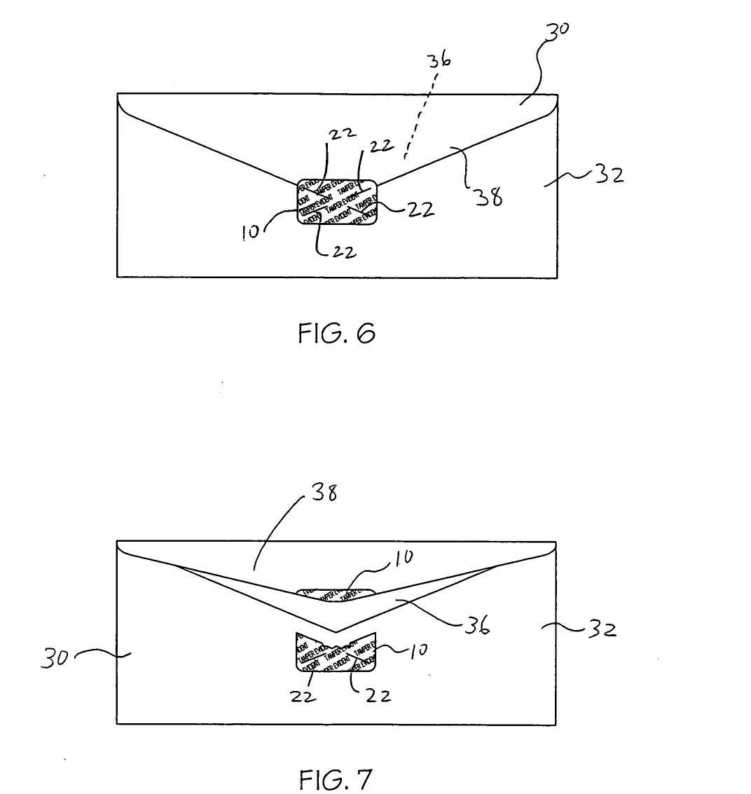

The tamper evident label 10 of FIGS. 1-4 may be used with an envelope, package, bag, file, folder, notebook, box, book, pouch, pocket, portfolio or other containment means 30, an example of which is shown in FIGS. 5-7. In particular, the envelope 30 may include an envelope body 32 having an inner cavity 34 and a mouth 36 which provides access to the inner cavity 34. The envelope 30 may include a flap 38 which is movable between an open position (FIG. 5) wherein the flap 38 generally does not cover the mouth 36, and a closed position (FIG. 6) wherein the flap 38 generally covers the mouth 36.

In order to utilize the tamper evident label 10 of FIGS. 1-4 with the envelope 30 of FIG. 5, the envelope 30 is moved to its closed position. The tamper evident label 10 is then applied to the envelope 30, adhesive side 16 down, to adhere the label 10 to the envelope 30. The label 10 should be applied such that the label 10 is adhered to both the flap 38 and the body portion 32 of the envelope 30 as shown in FIG. 6.

When the label 10 is securely adhered to the envelope 30, any attempted removal of the label 10 will generally result in tearing of the envelope 30 and/or of the label 10. For example, any attempted opening of the envelope 30 (i.e., attempted opening of the flap 38) may cause the label 10 to tear, for example, along the upper two tear guidelines 22, as shown in FIG. 7. Thus, the label 10 provides evidence of the tampering, or attempted tampering, of the envelope 30.

The diagonal configuration of the tear guidelines 22 allows the tamper evident label 10 to tear along a path to separate the label 10 into upper and lower fragments. Furthermore, the shape and arrangement of the diagonal tear guidelines 22 provide sufficient tear guidelines 22 to allow the label 10 to be relatively easily torn, but does not include so many tear guidelines 22 so as to compromise the strength of the label 10 which would make the label 10 difficult to handle and apply to the envelope 30. Furthermore, when using the label 10 of FIGS. 1-3, the upper tear guidelines 22 may be generally aligned with the lower edge of the flap 38 (which is generally “V”-shaped) such that attempted opening of the envelope 30 allows the label 10 to easily tear along the upper tear guidelines 22. In this case, the two upper tear guidelines 22 are generally “V”-shaped, although the two upper tear guidelines 22 (or in fact any of the other tear guidelines) may be combined into a single tear guideline rather than being separate, discreet tear guidelines.

Having described the invention in detail and by reference to the preferred embodiments, it will be apparent that modifications and variations thereof are possible without departing from the scope of the invention.

1. A tamper evident label system comprising a label sheet having an adhesive located thereon and at least one tear guide line or score line located thereon or therethrough, said label sheet including indicia indicating the tamper evident nature of said label.

2. The tamper evident label system of claim 1 wherein said label sheet is generally flat and includes an adhesive generally covering one side thereof.

3. The tamper evident label system of claim 2 wherein said label sheet is configured such that when said label sheet is adhered to a substrate by said adhesive, and any attempted removal of said label sheet from said substrate causes said label sheet to tear at or adjacent to said at least one tear guide line or score line.

4. The tamper evident label system of claim 1 wherein said label sheet is generally rectangular in top view.

5. The tamper evident label system of claim 4 wherein said label sheet includes at least two tear guide lines or score lines located thereon or therethrough.

6. The tamper evident label system of claim 4 wherein said label sheet includes four diagonally oriented tear guide lines or score lines located thereon or therethrough.

7. The tamper evident label system of claim 1 further including a containment means including a body, a flap, and an inner cavity having a mouth, and wherein said flap is movable between a closed position wherein said flap generally covers said mouth and an open position wherein said flap generally does not cover said mouth, and wherein said tamper evident label sheet is secured to said body and to said flap to maintain said flap in a closed position.

8. The tamper evident label system of claim 7 wherein said label sheet is securely adhered to said containment means such that any attempted removal of said label sheet from said containment means causes said label sheet to tear at or adjacent to said at least one tear guide line or score line or causes tearing of said containment means.

9. The tamper evident label system of claim 7 wherein attempted movement of said flap from said closed position to said open position generally causes said label sheet to tear at or adjacent to said at least one tear guide line or score line.

10. The tamper evident label system of claim 7 wherein said flap includes an outer edge, and wherein said at least one tear guide line or score line is generally aligned with said outer edge.

11. The tamper evident label system of claim 10 wherein said outer edge of said flap includes a generally “V” shaped tip, and wherein said at least one tear guide line or score line is generally “V” shaped and generally aligned with said tip.

12. The tamper evident label system of claim 11 wherein said at least one tear guide line includes at least two tear guide lines forming an angle therebetween, said tear guide lines being spaced apart from each other.

13. The tamper evident label system of claim 1 wherein said label sheet includes an outer perimeter, and wherein said at least one tear guide line is entirely spaced apart from said outer perimeter.

14. A tamper evident label system comprising:
a containment means including a body, a flap, and an inner cavity having a mouth, wherein said flap is movable between a closed position wherein said flap generally covers said mouth and an open position wherein said flap generally does not cover said mouth; and
a label sheet having an adhesive located thereon and at least one tear guide line or score line located thereon or therethrough, said label sheet being adhered to said flap and to said body to maintain said flap in said closed position.

15. The tamper evident label system of claim 14 wherein said label sheet includes indicia indicating the tamper evident nature of said label.

16. The tamper evident label system of claim 14 wherein said label sheet is generally flat and includes an adhesive generally covering one side thereof.

17. The tamper evident label system of claim 16 wherein said label sheet is securely adhered to said containment means such that any attempted removal of said label sheet from said containment means causes said label sheet to tear at or adjacent to said at least one tear guide line or score line or causes said containment means to tear.

18. The tamper evident label system of claim 16 wherein said label sheet is securely adhered to said containment means such that any attempted movement of said flap from said closed position to said open position generally causes said label sheet to tear at or adjacent to said at least one tear guide line or score line.

19. The tamper evident label system of claim 14 wherein said flap includes an outer edge, and wherein said at least one tear guide line or score line is generally aligned with said outer edge.

20. The tamper evident label system of claim 19 wherein said outer edge of said flap includes a generally “V” shaped tip, and wherein said at least one tear guide line or score line is generally “V” shaped and generally aligned with said tip.

21. The tamper evident label system of claim 14 wherein said label sheet is generally rectangular in top view.

22. The tamper evident label system of claim 21 wherein said label sheet includes at least two tear guide lines or score lines located thereon or therethrough.

23. The tamper evident label system of claim 21 wherein said label sheet includes four diagonally oriented tear guide lines or score lines located thereon or therethrough.

24. The tamper evident label system of claim 14 wherein said label sheet includes an outer perimeter, and wherein said at least one tear guide line is entirely spaced apart from said outer perimeter.

25. A tamper evident label system comprising a generally flat, generally rectangular label sheet having an outer perimeter and an adhesive located on one side thereof and four tear guide line or score line located thereon or therethrough, each tear guide line or score line being entirely spaced apart from said outer perimeter and being diagonally oriented, each tear guide line or score line extending from generally adjacent a corner of said label sheet to a center portion of said label sheet, said label sheet including indicia indicating the tamper evident nature of said label.

26. The tamper evident label system of claim 25 further including a containment means including a body, a flap, and an inner cavity having a mouth, and wherein said flap is movable between a closed position wherein said flap generally covers said mouth and an open position wherein said flap generally does not cover said mouth, and wherein said tamper evident label sheet is secured to said body and said flap to maintain said flap in said closed position, and wherein said label sheet is securely adhered to said containment means such that any attempted movement of said flap from said closed position to said open position generally causes said label sheet to tear at or adjacent to at least one of said tear guide lines or score lines.

27. A method for manipulating a containment means comprising steps of:
providing a containment means including a body, a flap, and an inner cavity having a mouth, wherein said flap is movable between a closed position wherein said flap generally covers said mouth and an open position wherein said flap generally does not cover said mouth, said flap being located in said closed position;
providing a tamper evident label including a label sheet having an adhesive located thereon and at least one tear guide line or score line located thereon; and
adhering said tamper evident label to said flap and said body to maintain said flap in said closed position.

28. The method of claim 27 wherein said label sheet includes indicia indicating the tamper evident nature of said label.
